(19) United States
(12) Patent Application Publication
(10) Pub. No.: US 2023/0408638 A1
(43) Pub. Date: Dec. 21, 2023

(54) REFERENCE POINT FOR CONFIGURING AN OBJECT COUNTER

(71) Applicant: Sensormatic Electronics, LLC, Boca Raton, FL (US)

(72) Inventors: James A. COOK, Boynton Beach, FL (US); John J. CLARK, Boynton Beach, FL (US)

(21) Appl. No.: 18/335,840

(22) Filed: Jun. 15, 2023

Related U.S. Application Data
(60) Provisional application No. 63/353,259, filed on Jun. 17, 2022.

(51) Int. Cl. G01S 7/06; G01S 13/88

(52) U.S. Cl. CPC G01S 7/06; G01S 13/88

(57) ABSTRACT

Example implementations include a system and method for providing a graphical user interface (GUI) on a display, wherein the GUI is operable for displaying a representation of a detection field of an object counting radar unit, wherein the GUI is operable for displaying a reference point that represents a rotatable object as detected by the object counting radar unit when the rotatable object is located in a field-of-view of the object counting radar unit and is rotated by a drive motor assembly.

### CROSS REFERENCE TO RELATED APPLICATION(S)

This application claims the priority of U.S. Provisional Application Ser. No. 63/353,259, entitled “REFERENCE POINT FOR CONFIGURING AN OBJECT COUNTER” and filed on Jun. 17, 2022, which is expressly incorporated by reference herein in the entirety.

### BACKGROUND

The present disclosure relates generally to object counting systems and methods, and more particularly, to configuring an object counter.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes a system comprising: a rotatable object; and a drive motor assembly operable to rotate the rotatable object, wherein the rotatable object is detectable by an object counting radar unit when the rotatable object is located in a field-of-view of the object counting radar unit and is rotated by the drive motor assembly.

Another example implementation includes a system comprising: one or more processors; and one or more memories each coupled with at least one of the one or more processors and each storing all or some portion of instructions that, when executed by the one or more processors, cause the one or more processors, individually or in any combination, to provide a graphical user interface “GUI” on a display, wherein the GUI is operable for displaying a representation of a detection field of an object counting radar unit, wherein the GUI is operable for displaying a reference point that represents a rotatable object as detected by the object counting radar unit when the rotatable object is located in a field-of-view of the object counting radar unit and is rotated by a drive motor assembly.

Another example implementation includes a method comprising: receiving data from an object counting radar unit; and displaying, based on the data, a representation of a detection field of the object counting radar unit on a graphical user interface “GUI,” including displaying a reference point that represents a rotatable object as detected by the object counting radar unit when the rotatable object is located in a field-of-view of the object counting radar unit and is rotated by a drive motor assembly.

Another example implementation includes an apparatus comprising means for receiving data from an object counting radar unit; and means for displaying, based on the data, a representation of a detection field of the object counting radar unit on a graphical user interface “GUI,” including displaying a reference point that represents a rotatable object as detected by the object counting radar unit when the rotatable object is located in a field-of-view of the object counting radar unit and is rotated by a drive motor assembly.

Another example implementation includes one or more non-transitory computer-readable mediums storing instructions individually or in combination, wherein the instructions, when executed by one or more processors individually or in combination, cause the one or more processors to receive data from an object counting radar unit; and display, based on the data, a representation of a detection field of the object counting radar unit on a graphical user interface “GUI,” including displaying a reference point that represents a rotatable object as detected by the object counting radar unit when the rotatable object is located in a field-of-view of the object counting radar unit and is rotated by a drive motor assembly.

Some further aspects are provided below.

1. A system comprising:
a rotatable object; and
a drive motor assembly operable to rotate the rotatable object, wherein the rotatable object is detectable by an object counting radar unit when the rotatable object is located in a field-of-view of the object counting radar unit and is rotated by the drive motor assembly.

2. The system of clause 1, wherein the rotatable object comprises a pinwheel or a fan blade.

3. The system of clause 1 or 2, further comprising a safety cage that at least partially covers the rotatable object.

4. The system of any one of clauses 1 to 3, further comprising a stand that supports the rotatable object and the drive motor assembly.

5. The system of clause 4, wherein a height of the stand is adjustable.

6. The system of clause 4 or 5, wherein the stand comprises a tripod.

7. The system of any one of clauses 1 to 6, further comprising the object counting radar unit.

8. The system of any one of clauses 1 to 7, further comprising a graphical user interface “GUI” operable for displaying a representation of a detection field of the object counting radar unit.

9. The system of clause 8, wherein the GUI is operable to display a reference point that represents the rotatable object as detected by the object counting radar unit.

10. The system of clause 8 or 9, wherein the GUI is further operable to display a representation of a portal, an In count line, and an Out count line, wherein the In count line and the Out count line are configured for object counting by the object counting radar unit.

11. The system of clause 10, wherein the representation of the portal comprises a representation of one or more electronic article surveillance “EAS” pedestals.

12. The system of any one of the above clauses, wherein the rotatable object provides a static point of reference for configuring the object counting radar unit.

13. A system comprising:
one or more processors; and
one or more memories each coupled with at least one of the one or more processors and each storing all or some portion of instructions that, when executed by the one or more processors, cause the one or more processors, individually or in any combination, to provide a graphical user interface “GUI” on a display, wherein the GUI is operable for displaying a representation of a detection field of an object counting radar unit, wherein the GUI is operable for displaying a reference point that represents a rotatable object as detected by the object counting radar unit when the rotatable object is located in a field-of-view of the object counting radar unit and is rotated by a drive motor assembly.

14. The system of clause 13, wherein the GUI is further operable to display a representation of a portal, an In count line, and an Out count line, wherein the In count line and the Out count line are configured for object counting by the object counting radar unit.

15. The system of clause 13 or 14, wherein the representation of the portal comprises a representation of one or more electronic article surveillance “EAS” pedestals.

16. The system of any one of clauses 13 to 15, wherein the rotatable object provides a static point of reference for configuring the object counting radar unit.

17. A method comprising:
receiving data from an object counting radar unit; and
displaying, based on the data, a representation of a detection field of the object counting radar unit on a graphical user interface “GUI,” including displaying a reference point that represents a rotatable object as detected by the object counting radar unit when the rotatable object is located in a field-of-view of the object counting radar unit and is rotated by a drive motor assembly.

18. The method of clause 17, further comprising displaying, on the GUI, a representation of a portal, an In count line, and an Out count line, wherein the In count line and the Out count line are configured for object counting by the object counting radar unit.

19. The method of clause 17 or 18, wherein the representation of the portal comprises a representation of one or more electronic article surveillance “EAS” pedestals.

20. The method of any one of clauses 17 to 19, wherein the rotatable object provides a static point of reference for configuring the object counting radar unit.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example system for configuring an object counter, according to aspects of the present disclosure;

FIG. 2 is a schematic diagram of an example graphical user interface (GUI) that is configured for configuring an object counter, according to aspects of the present disclosure;

FIG. 3 is a block diagram of an example computing device which may implement a component in the example system of FIG. 1, according to aspects of the present disclosure; and

FIG. 4 is a flow diagram of an example method of configuring an object counter, according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Aspects of the present disclosure implement a reference point for configuring an object counter, such as but not limited to a millimeter Wave (mmWave) radar people counter used at, for example, a retail store to count the number of people passing through a portal of the retail store, such as an entrance of the retail store monitored by a surveillance system of the retail store.

Turning now to the figures, example aspects are depicted with reference to one or more components described herein, where components in dashed lines may be optional.

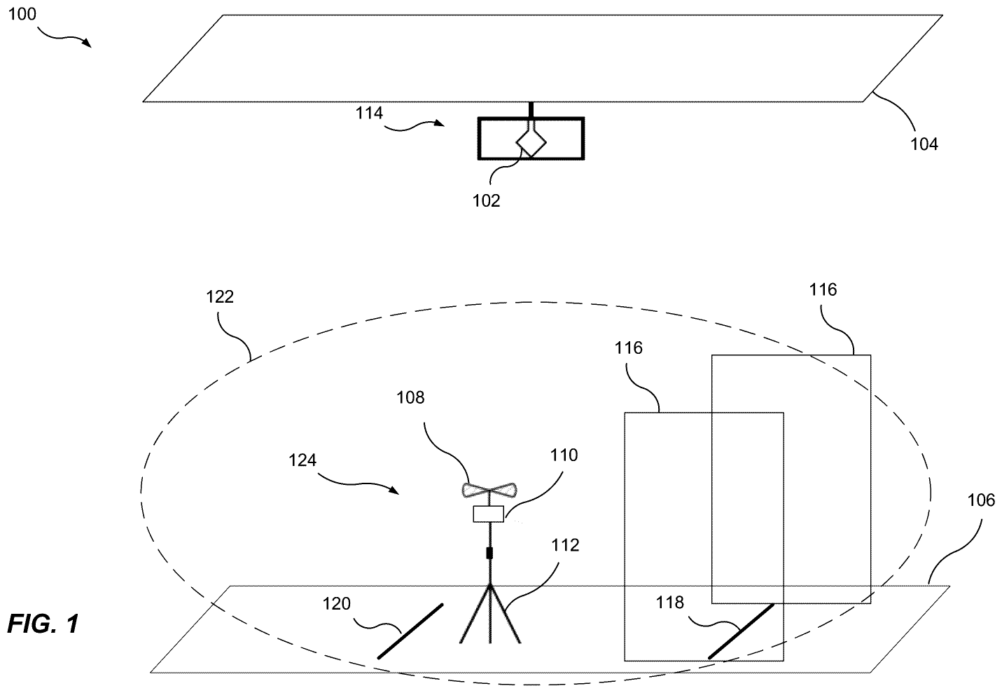

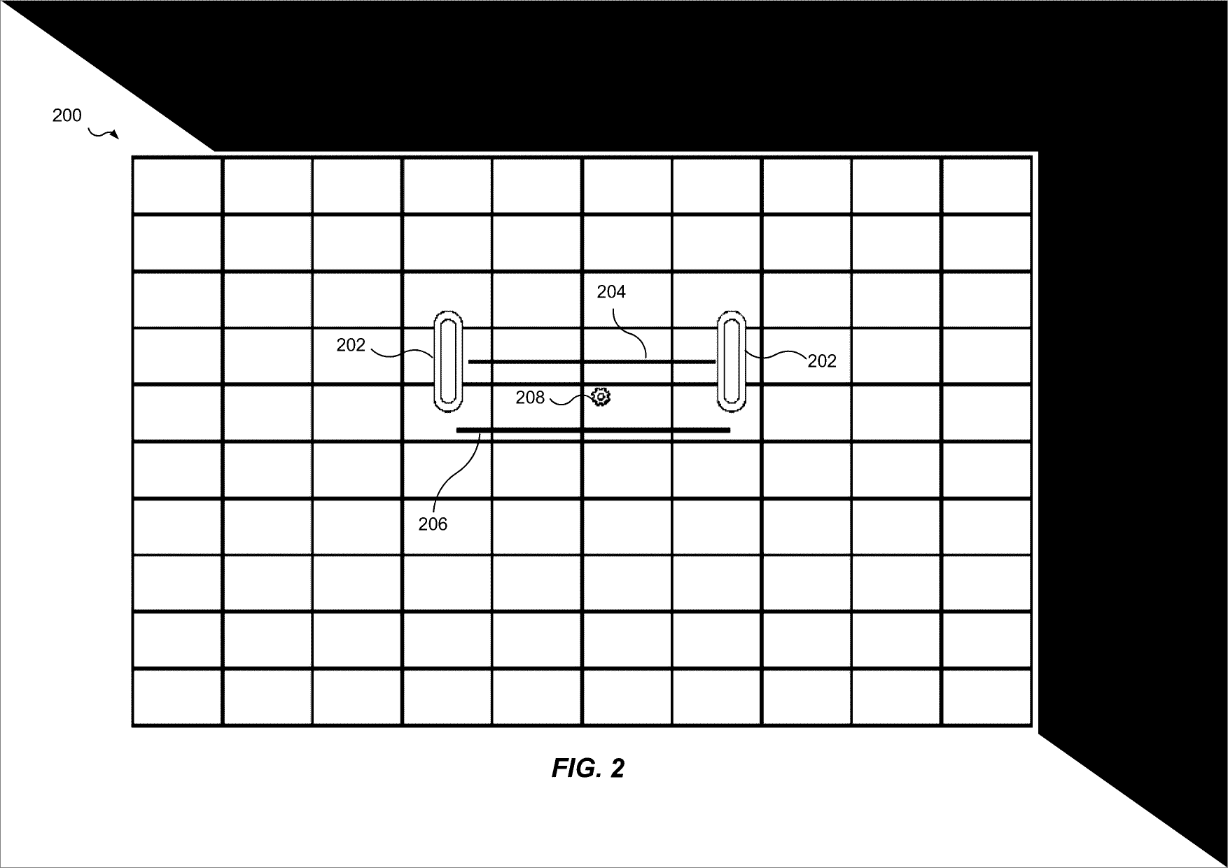

Referring to FIGS. 1 and 2, in one non-limiting aspect, a mmWave radar object counter 114 includes a mmWave high frequency radio-frequency (RF) transceiver such as a radar unit 102 that is typically mounted overhead, e.g., to a ceiling 104 in a retail environment 100. As used herein, mmWave signals are short-wavelength electromagnetic signals having a wavelength between 1 millimeter and 10 millimeters, or equivalently having a frequency between 30 GHz and 300 GHz. In one aspect, the radar unit 102 is configured to emit mmWave signals and measure reflections of those signals reflected by people walking in an area of observation 122 in the retail environment 100, so as to count the number of people walking within the area of observation 122. In these aspects, the radar unit 102 filters out any object that is not in motion.

In an aspect, for example, the area of observation 122 of the radar unit 102 may include portal delimiters such as one or more electronic article surveillance (EAS) pedestals 116, as well as an “In” count line 118 and an “Out” count line 120. The mmWave radar object counter 114 is configured to increment a count when a person crosses both the “In” count line 118 and the “Out” count line 120 in succession.

More specifically, for example, in one non-limiting aspect, based on signals emitted and received by the radar unit 102, the mmWave radar object counter 114 may monitor movements of objects in the area of observation 122. Based on the monitored movements, the mmWave radar object counter 114 may determine whether a moving object that has crossed the “In” count line 118 proceeds to cross the “Out” count line 120. If a moving object that has crossed the “In” count line 118 proceeds to cross the “Out” count line 120, the mmWave radar object counter 114 increments a count of people that have entered the retail environment 100 from the portal defined by the EAS pedestals 116. Alternatively and/or additionally, based on the monitored movements, the mmWave radar object counter 114 may determine whether a moving object that has crossed the “Out” count line 120 proceeds to cross the “In” count line 118. If a moving object that has crossed the “Out” count line 120 proceeds to cross the “In” count line 118, the mmWave radar object counter 114 increments a count of people that have exited the retail environment 100 from the portal defined by the EAS pedestals 116.

Although some present aspects include the EAS pedestals 116, the present aspects are not so limited, and in some other aspects the mmWave radar object counter 114 may be used for counting people in retail environments that do not include or implement any pedestals.

Although some present aspects include a single mmWave radar object counter 114, the present aspects are not so limited, and in some other aspects more than one mmWave radar object counters may be used for covering respective zones/areas to count people in the retail environment 100. For example, more than one mmWave radar object counters may be used for covering a cumulative area of observation that is the aggregate of the area of observation of each one of the mmWave radar object counters.

Although some present aspects include an object counter using mmWave radar technology, the present aspects are not so limited, and some other aspects may include an object counter using a radar technology operating at a frequency other than mmWave, an object counter using sonar technology, an object counter using light detection and ranging (LIDAR) technology, etc.

In some aspects, in order to count properly/accurately, the mmWave radar object counter 114 needs to be calibrated to have accurate reference points for the EAS pedestals 116, the “In” count line 118, and/or the “Out” count line 120. However, configuring the XY coordinates of the EAS pedestals 116, the “In” count line 118, and the “Out” count line 120 within the area of observation 122 is prone to inaccuracy for several reasons. Firstly, the radar unit 102 may not be placed in the center line of the EAS pedestals 116 and may be offset to the inside of the retail environment 100. Further, measuring the location of the EAS pedestals 116 in relation to the radar unit 102 may not be accurate without a laser tool. Even with an accurate measurement of the location of the EAS pedestals 116, the XY values are often not accurate when compared against the point-of-view of the radar unit 102. This may be due to the nature of the high frequency propagation, such as impedance mismatch through the cover, impedance mismatch to the air, and reflections. Additionally, the offset of the radar unit 102 from the area of observation 122 may contribute to a difference in measurement.

In some aspects, a best estimate may be made as someone walks close to the EAS

pedestals 116 while another person watches a graphical user interface (GUI) 200 (FIG. 2) of the radar unit 102 to determine the location of the EAS pedestals 116. However, this is not a static operation as one person is in motion. Further, these aspects require two people for configuring the mmWave radar object counter 114.

Some present aspects address the above issues by providing an apparatus 124 that allows for configuration of the mmWave radar object counter 114 by a single person in a static and deterministic manner. In one non-limiting aspect, for example, the apparatus 124 may include a drive motor assembly 110 and a rotatable object 108 attached to the drive motor assembly 110 which may include a direct current (DC) motor or an alternating current (AC) motor, for example. The rotatable object 108 is controllable/rotatable by the drive motor assembly 110. The rotatable object 108 may be placed in the radar field of the radar unit 102, and when rotated by the drive motor assembly 110, the rotatable object 108 is a target for the radar unit 102 to detect, and provides a static point of reference for configuring the radar unit 102.

In one non-limiting aspect, for example, the rotatable object 108 may be symmetrical and circular. In one non-limiting aspect, for example, the rotatable object 108 may include a fan with fan blades, a pinwheel, etc. In one non-limiting aspect, for example, the rotatable object 108 may be at least partially covered/surrounded by a safety ring/cage.

Optionally, the apparatus 124 may further include a stand such as an adjustable-height tripod 112 supporting the rotatable object 108 and the drive motor assembly 110. The adjustable-height tripod 112 may be placed on a floor 106 of the retail environment 100. In one non-limiting example aspect, the height of the adjustable-height tripod 112 may be adjustable between 1 foot and 4 feet.

In some aspects, the drive motor assembly 110 is operable to rotate the rotatable object 108 at a speed that is sufficient for radar detection by the radar unit 102. This speed may be different for different rotatable objects with different configurations, shapes, materials, etc. For safety reasons, the rotating speed is typically slow. In one non-limiting aspect, for example, the drive motor assembly 110 is operable to rotate the rotatable object 108 at a rate of 15 to 30 revolutions per minute (RPM), for example at 18 RPM.

In some aspects, the drive motor assembly 110 may be powered by wall power or by batteries. In one non-limiting example aspect, the drive motor assembly 110 may be controllable by an on/off switch and, optionally, a direction-of-rotation switch. Each of the switches may be in the form of a physical switch configured on the drive motor assembly 110 or a remote software switch implemented via a wired or wireless communication, e.g., a software switch controllable via the GUI 200. In some non-limiting aspects, the apparatus 124 may further include a battery pack, and an on/off switch may be configured locally on the adjustable-height tripod 112 to control an on/off operation of the drive motor assembly 110.

In one non-limiting aspect, for example, the adjustable-height tripod 112 may be placed in a portal away from walls and pedestals in “open air.” This decreases reflections from adjacent obstacles. In one non-limiting aspect, for example, the adjustable-height tripod 112 may be configured/adjusted to hold the rotatable object 108 at approximately 2 feet above the floor 106. In one non-limiting aspect, for example, measurements may be taken from the adjustable-height tripod 112 to the EAS pedestals 116 to ensure sufficient space therebetween. The drive motor assembly 110 is then turned on to spin the rotatable object 108, and a user/technician may view a representation of the location of the rotatable object 108 on the GUI 200 or via console data output. With the detected location of the rotatable object 108 as a known point as viewed from the point-of-view of the radar unit 102, other location values in the area of observation 122, such as the location of the EAS pedestals 116, the location of the “In” count line 118, the location of the “Out” count line 120, and any other parameters that rely on XY location may be set/configured for people counting by the mmWave radar object counter 114.

Although some present aspects include a stand such as the adjustable-height tripod 112, the present aspects are not so limited, and in some aspects the rotatable object 108 may be placed directly on the floor 106 without the adjustable-height tripod 112, or may be placed on other objects that act as a stand.

Although some present aspects define two count lines for object counting by the radar unit 102, the present aspects are not so limited. For example, in some alternative aspects, a single count line may be defined for object counting by the radar unit 102, while in some other alternative aspects, more than two count lines may be defined for object counting by a single radar unit 102.

For example, in some non-limiting aspects, the mmWave radar object counter 114 may be configured to increment a count when a moving object crosses a single count line defined in a portal of the retail environment 100.

In some other non-limiting aspects, for example, two sets of in and out count lines may be defined for object counting by a single radar unit 102. For example, at a portal of a retail store in one non-limiting aspect, a first EAS pedestal may be configured 2 meters away from a second EAS pedestal, which is in turn configured 2 meters away from a third EAS pedestal. In this case, a radar unit that can cover a 4-meter-wide observation area may be implemented for object counting using two sets of count lines: a first set of count lines defined between the first EAS pedestal and the second EAS pedestal, and a second set of count lines defined between the second EAS pedestal and the third EAS pedestal. The GUI 200 in this case may be configured to represent respective icons for each EAS pedestal and each count line.

Although some present aspects relate to configuring the mmWave radar object counter 114 using a rotatable object, the present aspects are not so limited, and some other aspects may configure the mmWave radar object counter 114 using any reflective object of any reflective material that is detectable by the radar unit 102 (e.g., metal, plastic, etc.). For example, some alternative aspects may use a vibrate-able object or a flap-able object, in place of or in addition to the rotatable object 108, for configuring the mmWave radar object counter 114.

Further, while the example aspects above relate to people counting in a retail environment, the present aspects are not so limited, and the present aspects are applicable to any portal where a radar is used for people counting and/or for counting/tracking objects other than people.

Referring to FIG. 2, a technician may use the GUI 200 for on-screen configuration of the radar object counting field of the radar unit 102. The GUI 200 is provided/supported by the mmWave radar object counter 114. In various aspects, the GUI 200 may be accessed, for example, via a computing device at a monitoring station, a virtual console, a web-based application running on a mobile device, a uniform resource locator (URL) reached via a web browser, etc.

In an aspect, when the rotatable object 108 is rotated by the drive motor assembly 110 within the area of observation 122 of the radar unit 102, the GUI 200 indicates a reference point icon 208 that represents the rotatable object 108 as interpreted from the point-of-view of the radar unit 102. The shape, color, size, or other visual characteristics of the reference point icon 208 may be pre-defined and/or may be configurable via one or more input/selection fields in the GUI 200. The reference point icon 208 facilitates proper on-screen location adjustment of egress endpoints such as one or more portal icons 202 representing the EAS pedestals 116. The reference point icon 208 further facilitates proper on-screen location adjustment of an “In” count line icon 204 representing the “In” count line 118 and an “Out” count line icon 206 representing the “Out” count line 120.

For example, in some aspects, in order to properly represent the EAS pedestals 116 as interpreted from the point-of-view of the radar unit 102, a technician may place the rotatable object 108 next to one of the EAS pedestals 116, causing the reference point icon 208 to indicate the location of that EAS pedestal 116 as interpreted from the point-of-view of the radar unit 102. Then, the technician may place a portal icon 202 on the on-screen location of the reference point icon 208 to represent that EAS pedestal 116 as interpreted from the point-of-view of the radar unit 102. This may be repeated for each EAS pedestal 116, as well as for the “In” count line 118 and the “Out” count line 120. Alternatively, once the portal icons 202 are placed on the GUI 200, the “In” count line icon 204 and the “Out” count line icon 206 may be placed on the GUI 200 in relation to the portal icons 202, either automatically or by the technician.

In some example aspects where there are no EAS pedestals in the area of observation 122 of the radar unit 102 (e.g., where the area of observation 122 corresponds to an entrance without EAS pedestals), the technician may properly locate the “In” count line 118 on the GUI 200 by placing the rotatable object 108 on the “In” count line 118 and then placing the “In” count line icon 204 on the on-screen location of the reference point icon 208 to represent the “In” count line 118 as interpreted from the point-of-view of the radar unit 10. This may be repeated for locating and representing the “Out” count line 120 on the GUI 200. Alternatively, once one of the “In” count line icon 204 or the “Out” count line icon 206 is located/placed on the GUI 200 using the rotatable object 108, the other count line may be placed on the GUI 200 in relation to the already-located count line, either automatically or by the technician.

In some non-limiting alternative or additional example aspects, the mmWave radar object counter 114 may be configured to automatically display the portal icons 202, the “In” count line icon 204, and the “Out” count line icon 206 on the GUI 200 in relation to the reference point icon 208. For example, the mmWave radar object counter 114 may be configured to identify the detected location of the rotatable object 108 as a known pre-defined location relative to one or more of the EAS pedestals 116, the “In” count line 118, and/or the “Out” count line 120. For example, the known pre-defined location may be pre-defined to fall on one of the EAS pedestals 116, halfway in between a center or an end of two opposing EAS pedestals 116, the middle or an end of the “In” count line 118, the middle or an end of the “Out” count line 120, etc. Subsequently, the technician may place the rotatable object 108 at the known pre-defined location relative to the EAS pedestals 116, the “In” count line 118, and/or the “Out” count line 120. Upon detecting the rotatable object 108 and indicating the reference point icon 208 on the GUI 200 to represent the rotatable object 108 as interpreted from the point-of-view of the radar unit 102, the mmWave radar object counter 114 may automatically display the portal icons 202, the “In” count line icon 204, and/or the “Out” count line icon 206 on the GUI 200 in relation to the reference point icon 208. The mmWave radar object counter 114 may be pre-configured to perform this automatic icon display based on the presumed location of the rotatable object 108 being the known pre-defined location relative to the EAS pedestals 116, the “In” count line 118, and/or the “Out” count line 120, and based on the presumed size/configuration of the EAS pedestals 116, the “In” count line 118, and/or the “Out” count line 120, relative to one another.

In some optional aspects, each one of the portal icons 202, the “In” count line icon 204, and the “Out” count line icon 206 may be turned on or off via the GUI 200, for example, by checking a respective checkbox.

In some example aspects where there are no EAS pedestals in the area of observation 122 of the radar unit 102 (e.g., where the area of observation 122 corresponds to an entrance/portal without EAS pedestals), a generic delimiter such as a vertical line may be displayed instead of on-screen GUI pedestal icons. For example, in some aspects, the radar unit 102 may monitor up to two 2.4 meter zones. In the case where the radar unit 102 is monitoring a field-of-view without EAS pedestals and large enough to warrant subdivision into two zones, three delimiters (e.g., three vertical lines) may be placed on-screen in the GUI 200 to define the boundaries of the portal. In some optional aspects, the generic delimiters may be turned off, for example, by checking a respective checkbox.

As compared to systems where one technician walks in the radar field and another technician configures the radar unit 102, the present aspects allow for configuring the radar unit 102 with only one technician. Additionally, as compared to configuring the radar unit 102 with one technician walking and another technician configuring the radar unit 102, the static placement of the rotatable object 108 provides faster configuration speed and better configuration accuracy.

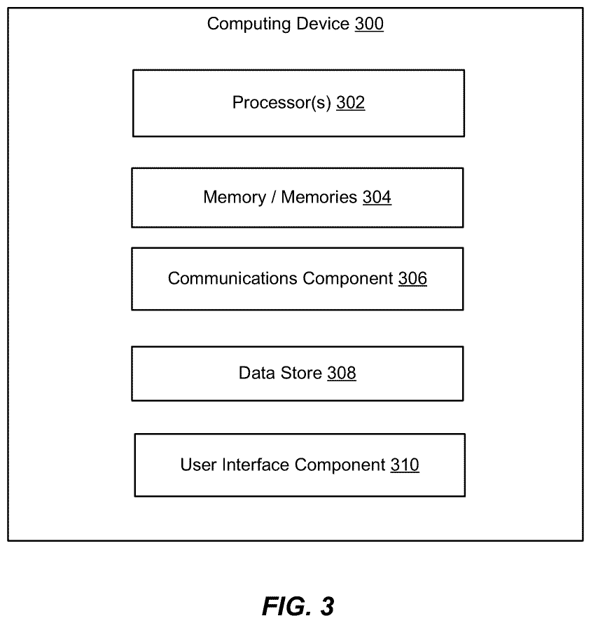

FIG. 3 illustrates an example block diagram providing details of computing components in a computing device 300 that may implement all or a portion of the mmWave radar object counter 114, the radar unit 102, the GUI 200, or any other component described with reference to FIGS. 1 and 2 above. The computing device 300 includes one or more processors 302 which may be configured to execute or implement software, hardware, and/or firmware modules that perform any functionality described herein with reference to the mmWave radar object counter 114, the radar unit 102, the GUI 200, or any other component described with reference to FIGS. 1 and 2 above.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The one or more processors 302 may include a micro-controller and/or may include a single or multiple set of processors or multi-core processors. Moreover, the one or more processors 302 may be implemented as an integrated processing system and/or a distributed processing system.

The computing device 300 may further include one or more memories 304, such as for storing local versions of applications being executed by the one or more processor 302, related instructions, parameters, etc. The one or more memories 304 may include a type of memory usable by a computer, such as random access memory (RAM), read only memory (ROM), tapes, magnetic discs, optical discs, volatile memory, non-volatile memory, and any combination thereof. Additionally, the one or more processors 302 and the one or more memories 304 may include and execute an operating system executing on the one or more processors 302, one or more applications, display drivers, etc., and/or other components of the computing device 300.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Further, the computing device 300 may include a communications component 306 that provides for establishing and maintaining communications with one or more other devices, parties, entities, etc. utilizing hardware, software, and services. The communications component 306 may carry communications between components on the computing device 300, as well as between the computing device 300 and external devices, such as devices located across a communications network and/or devices serially or locally connected to the computing device 300. For example, the communications component 306 may include one or more buses, and may further include transmit chain components and receive chain components associated with a wireless or wired transmitter and receiver, respectively, operable for interfacing with external devices.

Additionally, the computing device 300 may include a data store 308, which can be any suitable combination of hardware and/or software, that provides for mass storage of information, databases, and programs. For example, the data store 308 may be or may include a data repository for applications and/or related parameters not currently being executed by the one or more processors 302. In addition, the data store 308 may be a data repository for an operating system, application, display driver, etc., executing on the one or more processors 302, and/or one or more other components of the computing device 300.

The computing device 300 may also include a user interface component 310 operable to receive inputs from a user of the computing device 300 and further operable to generate outputs for presentation to the user (e.g., via a display interface to a display device). The user interface component 310 (e.g., implementing the GUI 200) may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 310 may include one or more output devices, including but not limited to a display interface, a speaker, a haptic feedback mechanism, a printer, any other mechanism capable of presenting an output to a user, or any combination thereof.

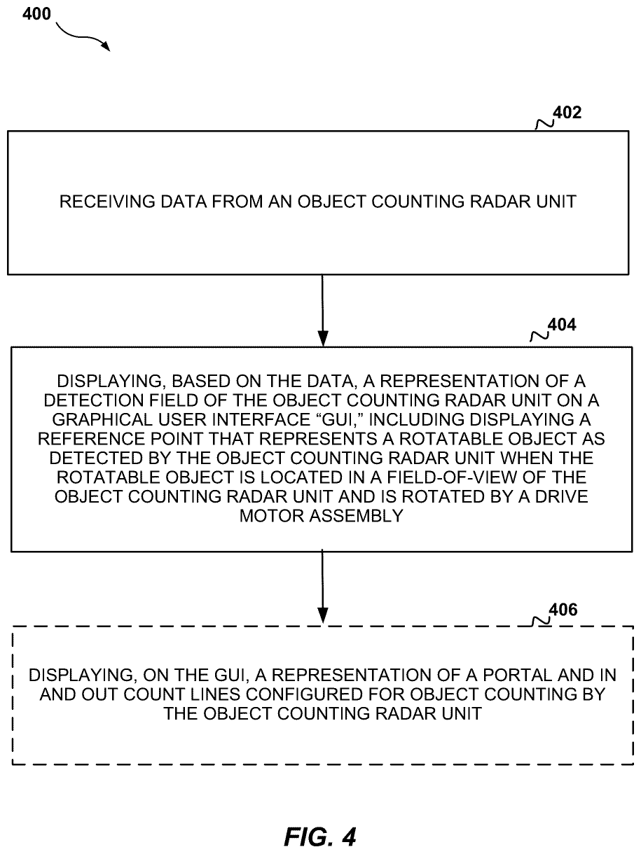

FIG. 4 is a flowchart of a method 400 for configuring an object counting radar unit, such as the mmWave radar object counter 114. The method 400 may implement the functionality described herein with reference to FIGS. 1-3 above, and may be performed by one or more components of the computing device 300 and/or one or more components of the mmWave radar object counter 114, the radar unit 102, the GUI 200, or any other component described with reference to FIGS. 1-3 above.

At 402, the method 400 includes receiving data from an object counting radar unit. For example, in an aspect, one or more components of the computing device 300, the mmWave radar object counter 114, and/or the GUI 200 may receive data from the radar unit 102. Accordingly, one or more components of the computing device 300, the mmWave radar object counter 114, and/or the GUI 200 may provide means for receiving data from an object counting radar unit.

At 404, the method 400 includes displaying, based on the data, a representation of a detection field of the object counting radar unit on a graphical user interface “GUI,” including displaying a reference point that represents a rotatable object as detected by the object counting radar unit when the rotatable object is located in a field-of-view of the object counting radar unit and is rotated by a drive motor assembly. For example, one or more components of the computing device 300, the mmWave radar object counter 114, and/or the GUI 200 may display, based on the data received from the radar unit 102, a representation of a detection field of the radar unit 102 on the GUI 200, including displaying the reference point icon 208 that represents the rotatable object 108 as detected by the radar unit 102 when the rotatable object 108 is located in a field-of-view of the radar unit 102 and is rotated by the drive motor assembly 110. Accordingly, one or more components of the computing device 300, the mmWave radar object counter 114, and/or the GUI 200 may provide means for displaying, based on the data, a representation of a detection field of the object counting radar unit on a graphical user interface “GUI,” including displaying a reference point that represents a rotatable object as detected by the object counting radar unit when the rotatable object is located in a field-of-view of the object counting radar unit and is rotated by a drive motor assembly.

Optionally, at 406, the method 400 may further include displaying, on the GUI, a representation of a portal, an In count line, and an Out count line, wherein the In count line and the Out count line are configured for object counting by the object counting radar unit. For example, one or more components of the computing device 300, the mmWave radar object counter 114, and/or the GUI 200 may display, on the GUI, a representation of a portal, such as the portal icons 202 representing the EAS pedestals 116, the “In” count line icon 204 representing the “In” count line 118, and the “Out” count line icon 206 representing the “Out” count line 120, configured for object counting by the radar unit 102. Accordingly, one or more components of the computing device 300, the mmWave radar object counter 114, and/or the GUI 200 may provide means for displaying, on the GUI, a representation of a portal, an In count line, and an Out count line, wherein the In count line and the Out count line are configured for object counting by the object counting radar unit.

In some optional implementations, the representation of the portal may comprise a representation of one or more electronic article surveillance “EAS” pedestals.

In some optional implementations, the rotatable object may provide a static point of reference for configuring the object counting radar unit.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A system comprising:
an object counting radar unit;
a rotatable object; and
a drive motor assembly operable to rotate the rotatable object, wherein the rotatable object is detectable by the object counting radar unit when the rotatable object is located in a field-of-view of the object counting radar unit and is rotated by the drive motor assembly.

2. The system of claim 1, wherein the rotatable object comprises a pinwheel or a fan blade.

3. The system of claim 1, further comprising a safety cage that at least partially covers the rotatable object.

4. The system of claim 1, further comprising a stand that supports the rotatable object and the drive motor assembly.

5. The system of claim 4, wherein a height of the stand is adjustable.

6. The system of claim 4, wherein the stand comprises a tripod.

7. The system of claim 1, further comprising a graphical user interface “GUI” operable for displaying a representation of a detection field of the object counting radar unit.

8. The system of claim 7, wherein the GUI is operable to display a reference point that represents the rotatable object as detected by the object counting radar unit.

9. The system of claim 8, wherein the GUI is further operable to display a representation of a portal, an In count line, and an Out count line.

10. The system of claim 9, wherein the In count line and the Out count line are configured for object counting by the object counting radar unit.

11. The system of claim 9, wherein the representation of the portal comprises a representation of one or more electronic article surveillance “EAS” pedestals.

12. The system of claim 1, wherein the rotatable object provides a static point of reference for configuring the object counting radar unit.

13. A system comprising:
one or more processors; and
one or more memories each coupled with at least one of the one or more processors and each storing all or some portion of instructions that, when executed by the one or more processors, cause the one or more processors, individually or in any combination, to provide a graphical user interface “GUI” on a display, wherein the GUI is operable for displaying a representation of a detection field of an object counting radar unit, wherein the GUI is operable for displaying a reference point that represents a rotatable object as detected by the object counting radar unit when the rotatable object is located in a field-of-view of the object counting radar unit and is rotated by a drive motor assembly.

14. The system of claim 13, wherein the GUI is further operable to display a representation of a portal, an In count line, and an Out count line, wherein the In count line and the Out count line are configured for object counting by the object counting radar unit.

15. The system of claim 14, wherein the representation of the portal comprises a representation of one or more electronic article surveillance “EAS” pedestals.

16. The system of claim 13, wherein the rotatable object provides a static point of reference for configuring the object counting radar unit.

17. A method comprising:
receiving data from an object counting radar unit; and
displaying, based on the data, a representation of a detection field of the object counting radar unit on a graphical user interface “GUI,” including displaying a reference point that represents a rotatable object as detected by the object counting radar unit when the rotatable object is located in a field-of-view of the object counting radar unit and is rotated by a drive motor assembly.

18. The method of claim 17, further comprising displaying, on the GUI, a representation of a portal, an In count line, and an Out count line, wherein the In count line and the Out count line are configured for object counting by the object counting radar unit.

19. The method of claim 18, wherein the representation of the portal comprises a representation of one or more electronic article surveillance “EAS” pedestals.

20. The method of claim 17, wherein the rotatable object provides a static point of reference for configuring the object counting radar unit.
